(19) United States
(12) Patent Application Publication
(10) Pub. No.: US 2008/0173331 A1
(43) Pub. Date: Jul. 24, 2008

(54) Method for producing battery can

(76) Inventors: Toru Morimoto, Nara (JP); Katsuhiko Mori, Osaka (JP); Masatoshi Hano, Osaka (JP)

Correspondence Address: MCDERMOTT WILL & EMERY LLP, 600 13TH STREET, NW, WASHINGTON, DC, 20005-3096, US

(21) Appl. No.: 11/902,828

(22) Filed: Sep. 26, 2007

(30) Foreign Application Priority Data
Sep. 27, 2006 (JP) 2006-262630

(51) Int. Cl. B08B 7/04

(52) U.S. Cl. 134/18

(57) ABSTRACT

A method for producing a battery can including the steps of: (1) making a battery can having a cylindrical body, a bottom, and an opening from a steel plate; (2) cleaning the battery can with water; and (3) heating and drying the battery can by transporting the battery can through a high frequency induction heater after the step (2). In the step (3), the battery can is placed such that the angle between a horizontal plane and the direction extending from the bottom to the opening along the central axis of the battery can in the longitudinal direction of the cylindrical body is approximately 0° to 90°. The heater has an opening in an upper part of the transport route of the battery can and is placed so as not to face the opening of the battery can.

### FIELD OF THE INVENTION

The invention relates to methods for producing battery cans, and more particularly, to a method for drying a battery can that has been cleaned with water.

### BACKGROUND OF THE INVENTION

In conventional methods for producing battery cans, battery cans obtained by a can making process are cleaned with CFC. Water can be used instead of CFC to clean the battery cans. However, in the case of water cleaning, water adhering to the battery cans causes rust, and the battery cans are thus susceptible to corrosion. To prevent the corrosion of the battery cans, it is necessary to dry the battery cans after water cleaning.

With respect to drying methods, for example, Japanese Laid-Open Patent Publication No. Hei 9-129191 proposes heat-drying battery cans by passing the battery cans through a high frequency induction heater with the openings of the battery cans downward.

FIG. 6 illustrates a step of drying battery cans by using a conventional high frequency induction heater.

In the drying step, battery cans 7 placed on a conveyer 24 are transported into a transport route 28 of a high frequency induction heater 20. The conveyer 24 is capable of securing the battery cans 7 with magnets and transporting them in the direction of arrow Q5 shown in FIG. 6. The conveyer 24 has a wire mesh structure so that water coming out of the openings 2 of the battery cans 7 can be discharged. The battery cans 7 are placed on the conveyer 24 such that the openings 2 point downward.

The heater 20 is shaped like U in the cross-section in the direction perpendicular to the transport direction (direction of arrow Q5) of the battery cans 7. The heater 20 is composed of a heating coil 21 comprising a laminate of a plurality of coil elements 21d, a coil support 22 supporting the heating coil 21, and an outer case 23 housing the heating coil 21 and the coil support 22. The heating coil 21 is composed of coil portions 21a, which face the cylindrical bodies 3 of the battery cans 7, and a coil portion 21b, which faces the bottoms 1 of the battery cans 7.

When a high frequency alternating current is applied to the heating coil 21, a magnetic field is established in the transport route 28 of the heater 20. When the battery cans 7 are transported into the transport route 28 (alternating field) by the conveyer 24, a voltage is induced in the battery cans 7 due to electromagnetic induction, so that an induced current flows through the battery cans 7. As a result, a large amount of Joule's heat is produced in the battery cans 7 and the battery cans 7 are heated. In this way, the battery cans 7 can be dried.

As described above, the battery cans 7 are placed on the conveyer 24 with the openings 2 downward, and the heater 20 is placed such that the heating coil 21 faces the cylindrical bodies 3 and bottoms 1 of the battery cans 7. Hence, steam tends to remain in the battery cans 7, thereby resulting in a reduction in the efficiency of drying of the inner face of the battery cans 7. Also, since the heating coil 21 is provided above the battery cans 7, steam from the surface of the battery cans 7 adheres to the heating coil 21, which may cause a failure of the heater 20.

It is therefore an object of the invention to provide a method for producing a battery can which is capable of efficiently drying the battery can and suppressing the adhesion of steam from the surface of the battery can to a high frequency induction heater when drying the battery can.

### BRIEF SUMMARY OF THE INVENTION

The invention is directed to a method for producing a battery can including the steps of: (1) making a battery can having a cylindrical body, a bottom, and an opening from a steel plate; (2) cleaning the battery can with water; and (3) heating and drying the battery can by transporting the battery can through a high frequency induction heater after the step (2). In the step (3), the battery can is placed such that the angle between the horizontal plane and the direction extending from the bottom to the opening along the central axis of the battery can in the longitudinal direction of the cylindrical body is approximately 020 to 90°. The heater has an opening in an upper part of the transport route of the battery can and is placed so as not to face the opening of the battery can.

According to the invention, it is possible to provide a method for cleaning and drying a battery can which is capable of efficiently drying the battery can and suppressing the adhesion of steam from the surface of the battery can to a high frequency induction heater when drying the battery can.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a perspective view schematically showing a drying step of Embodiment 1 in a method for producing a battery can according to the invention;

FIG. 2 is a top view of FIG. 1;

FIG. 3 is a perspective view schematically showing a drying step of Embodiment 2 in a method for producing a battery can according to the invention;

FIG. 4 is a perspective view schematically showing a drying step of Embodiment 3 in a method for producing a battery can according to the invention;

FIG. 5 is a perspective view schematically showing a drying step of Embodiment 4 in a method for producing a battery can according to the invention; and

FIG. 6 is a perspective view schematically showing a drying step in a conventional method for producing a battery can.

### DETAILED DESCRIPTION OF THE INVENTION

The invention relates to a method for producing a battery can including the steps of cleaning and drying the battery can. That is, the battery can production method of the invention includes the steps of: (1) making a battery can having a cylindrical body, a bottom, and an opening from a steel plate; (2) cleaning the battery can with water; and (3) heating and drying the battery can by transporting the battery can through a high frequency induction heater after the step (2).

In the step (1), a battery can can be obtained, for example, by applying a drawing process and an ironing process to a cold-rolled steel plate. Also, for example, a DI (Drawing and Ironing) process is used as a can making process since it can enhance the productivity of battery cans and reduce costs. In the DI process, a cup-shaped intermediate product is made by a deep drawing process using a press, and the cup-shaped intermediate product is successively drawn and ironed to obtain a battery can of a predetermined shape.

In the step (1), lubricant may be used to assist the working of the steel plate and prevent the steel plate from breaking when worked. If the lubricant adheres to the battery can in the step (1), the lubricant can be removed by the cleaning water in the step (2) and the cleaning water adhering to the battery can can be removed in the step (3).

In the step (2), for example, hot water is used as the cleaning water. The temperature of the hot water is, for example, 40 to 60° C.

One method for removing the water is spraying air onto the battery can. However, with this method, it is difficult to completely remove the water adhering to the inner face of the battery can. Thus, in the step (3), the battery can is heated and dried by using a high frequency induction heater, as described later, so that the water adhering to the surface of the battery can, particularly the water adhering to the inner face of the battery can, can be removed completely.

According to the invention, in the step (3), the battery can is placed such that the angle between the horizontal plane and the direction extending from the bottom to the opening along the central axis of the battery can in the longitudinal direction of the cylindrical body is approximately 0° to 90°. Also, the high frequency induction heater has an opening in an upper part of the transport route of the battery can and is placed so as not to face the opening of the battery can.

It is therefore possible to efficiently dry the battery can and prevent steam from the surface of the battery can from adhering to the heater when heating the battery can. The above-mentioned angle is preferably approximately 90° since the inner face of the battery can dries more efficiently.

In the following Embodiments of the battery can production method of the invention, the step for drying a battery can for removing the cleaning water adhering to the battery can (the step (3)) is described.

### EMBODIMENT 1

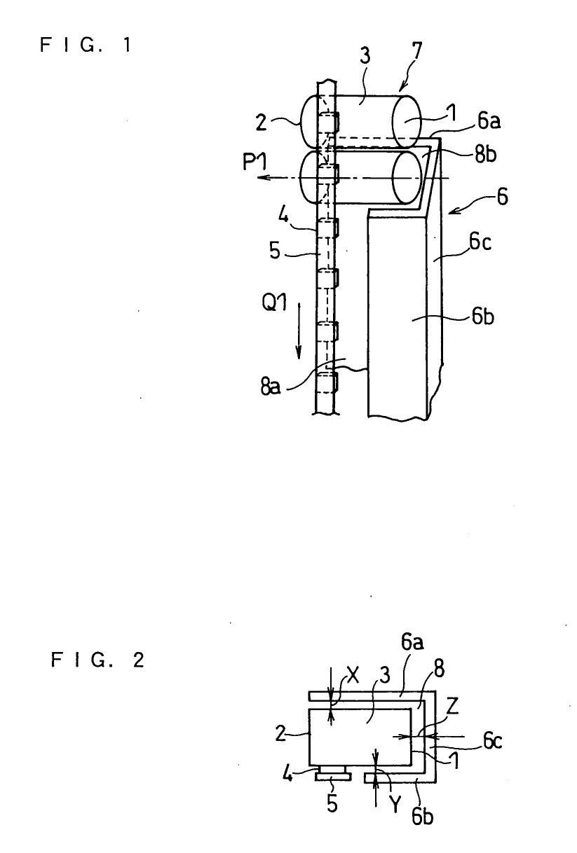

FIG. 1 illustrates a drying step in a battery can production method in this embodiment. FIG. 1 is a perspective view schematically showing a step of drying battery cans.

Each of cylindrical battery cans 7 has a bottom 1, a cylindrical body 3, and an opening 2. After a can making step (the step (1)) and a cleaning step using water (the step (2)), the battery cans 7 are transported into a high frequency induction heater 6 by a magnet conveyer 5, as shown in FIG. 1. The arrow P1 in FIG. 1 represents the direction extending from the bottom 1 to the opening 2 along the central axis of the battery can 7 in the longitudinal direction of the cylindrical body 3 of the battery can 7. The arrow Q1 in FIG. 1 represents the transport direction of the battery can 7.

FIG. 2 is a top view of FIG. 1. As illustrated in FIG. 2, the high frequency induction heater 6 is shaped like U in the cross section in the direction perpendicular to the transport direction (the direction of the arrow Q1) of the battery can 7. The heater 6 is composed of side walls 6a and 6b and a bottom 6c, which are equipped with a heating coil on the inner side thereof. The heater 6 has an opening 8a along the longitudinal direction thereof (the direction of the arrow Q1). In the heater 6, a transport space 8 is formed along the longitudinal direction of the heater 6 as a transport route for transporting the battery cans 7 therethrough. The heater 6 has an entrance 8b at one end of the transport space 8, and an exit (not shown) at the other end of the transport space 8. In this embodiment, the heater 6 is placed such that the transport entrance 8b and the transport exit are positioned in upper and lower parts of the transport route, respectively, and that the battery cans 7 are transported vertically.

Along the opening 8a of the transport space, the magnet conveyer 5 is disposed in the longitudinal direction of the transport space 8 (the transport direction of the battery cans 7). The magnet conveyer 5 has magnets 4 for securing the battery cans 7 at a constant interval. In order to prevent the magnets 4 from deteriorating due to heat from the heater 6, the height of the side wall 6b is designed to be less than that of the side wall 6a so that the side wall 6b does not extend to the magnet conveyer 5.

In the transport space 8 of the heater 6, the opening 2 of each of the battery cans 7 faces the opening 8a of the heater 6, the bottom 1 of the battery can 7 faces the bottom 6c of the heater 6, and the cylindrical body 3 of the battery can 7 faces the side walls 6a and 6b of the heater 6. That is, the heater 6 is disposed so as to face the cylindrical body 3 and bottom 1 of the battery can 7. The battery can 7 is secured to the magnet conveyer 5 by the contact of the cylindrical body 3 with the magnet 4. As illustrated in FIG. 1, the magnets 4 are disposed at such an interval that each magnet 4 can firmly receive each battery can 7.

In FIG. 2, the sizes of the clearance X between the cylindrical body 3 and the side wall 6a, the clearance Y between the cylindrical body 3 and the side wall 6b, and the clearance Z between the bottom 1 and the bottom 6c are, for example, X=Y=2 to 10 mm and Z=2 to 35 mm. Provided that the battery can and the heater (coil) do not come into contact with each other, the shorter the sizes of X and Y, the better. The size Z can be determined in consideration of the drying temperature of the battery can. The closer the battery can is to the heater (coil), i.e., the smaller the size of Z, the higher the drying temperature of the battery can. With respect to the combination of the sizes of X, Y, and Z, for example, X=4 mm, Y=4 mm, and Z=18 mm. The sizes of X, Y, and Z may be selected as appropriate, depending on the drying temperature of the battery can.

Each of the battery cans 7 is placed such that the angle between the horizontal plane and the direction extending from the bottom 1 to the opening 2 along the central axis of the battery can 7 in the longitudinal direction of the cylindrical body 3 (the direction of the arrow P1) is approximately 0°, i.e., the direction of the arrow P1 is substantially parallel to the horizontal plane.

In the configuration as described above, the process in which the battery cans 7 are heated and dried by the high frequency induction heater is described.

The battery cans 7 in the transport space 8 of the heater 6 are secured to the magnets 4 at a certain interval and transported by the magnet conveyer 5 in the direction substantially perpendicular to the horizontal plane from up to down (the direction of the arrow Q1 in FIG. 1). When an alternating current flows through the heating coil of the heater 6, a magnetic field is established in the transport space 8. When the battery cans 7, which are conductors, are passed through the magnetic field (i.e., the transport space 8), a voltage is induced in the battery cans 7, so that an induced current (eddy current) flows through the battery cans 7. This current produces Joule's heat in the battery cans 7, so that the battery cans 7 are heated and water adhering to the battery cans 7 evaporates. In this way, the battery cans 7 can be dried and the water adhering to the battery cans 7 can be removed.

In the above configuration, the battery cans 7 are placed such that the direction of the arrow P1 is substantially parallel to the horizontal plane. Thus, the steam inside the battery cans 7 is readily discharged without remaining therein.

Also, the heater 6 is disposed such that the transport entrance 8b is positioned in an upper part of the transport space 8 of the battery cans 7 and that the openings 2 of the battery cans 7 face the opening 8a. Hence, the steam is prevented from flowing upward into the heater 6, so that the steam is unlikely to adhere to the heater 6. As a result, the failure of the heater 6 due to the adhesion of water can be suppressed.

Further, since the battery cans 7 are transported in the direction substantially perpendicular to the horizontal plane from up to down, the adhesion of steam to the dried battery cans 7 is suppressed.

### EMBODIMENT 2

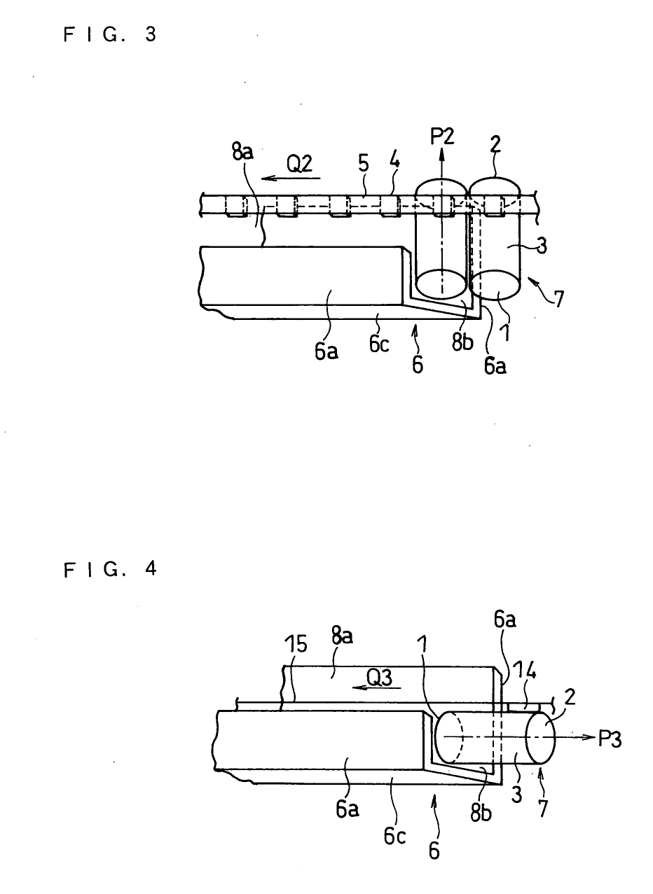

FIG. 3 illustrates a drying step in a battery can production method in this embodiment. FIG. 3 is a perspective view schematically showing a step of drying battery cans in this embodiment. The arrow P2 in FIG. 3 represents the direction extending from the bottom to the opening along the central axis of the battery can 7 in the longitudinal direction of the cylindrical body 3. The arrow Q2 in FIG. 3 represents the transport direction of the battery cans 7.

This embodiment is the same as Embodiment 1, except that the orientations of the heater 6 and the magnet conveyer 5 are changed such that the battery cans 7 are transported in the direction substantially parallel to the horizontal plane from right to left. That is, the positional relation between the battery cans 7 and the heater 6 is the same as that in Embodiment 1.

Each of the battery cans 7 is placed such that the angle between the horizontal plane and the direction extending from the bottom 1 to the opening 2 along the central axis of the battery can 7 in the longitudinal direction of the cylindrical body 3 is approximately 90°. That is, the battery cans 7 are placed such that the direction of the arrow P2 is substantially perpendicular to the horizontal plane and that the openings 2 point upward. Hence, the steam inside the battery cans 7 is readily discharged without remaining in the can. Since the openings 2 point upward, the water adhering to the inner face of the battery cans 7 can be removed more easily in this embodiment than in Embodiment 1.

Also, the heater 6 is disposed such that the opening 8a is positioned in an upper part of the transport space 8 of the battery cans 7 and that the openings 2 of the battery cans 7 face the opening 8a. Hence, the steam is prevented from flowing upward into the heater 6, so that the steam is unlikely to adhere to the heater 6. As a result, the failure of the heater 6 due to the adhesion of water can be suppressed.

Further, since the battery cans 7 are transported in the direction substantially parallel to the horizontal plane from right to left, the adhesion of steam to the dried battery cans 7 is suppressed.

### EMBODIMENT 3

FIG. 4 illustrates a drying step in a battery can production method in this embodiment. FIG. 4 is a perspective view schematically showing a step of drying battery cans in this embodiment. The arrow P3 in FIG. 4 represents the direction extending from the bottom to the opening along the central axis of the battery can 7 in the longitudinal direction of the cylindrical body 3. The arrow Q3 in FIG. 4 represents the transport direction of the battery can 7.

This embodiment is the same as Embodiment 2, except that a magnet conveyer 15 is used instead of the magnet conveyer 5, and that the orientation of the battery can 7 is changed such that the battery can 7 with the opening 2 rightward and the bottom leftward is passed through the heater 6 in the direction substantially parallel to the horizontal plane from right to left.

The magnet conveyer 15 is provided with magnets 14 for securing the battery cans 7. The magnets 14 are disposed at such a certain interval that each magnet 14 can firmly receive each battery can 7, as illustrated in FIG. 4. The magnet conveyer 15 having the magnets 14 on the lower face thereof is disposed along the opening 8a in the longitudinal direction of the heater 6.

In the transport space 8 of the heater 6, the opening 2 of the battery can 7 faces the transport entrance 8b of the heater 6, the bottom 1 of the battery can 7 faces the transport exit of the heater 6, and the cylindrical body 3 of the battery can 7 faces the side walls 6a and 6b and bottom 6c of the heater 6. That is, the heater 6 is disposed so as to face the cylindrical body 3 of the battery can 7.

The battery can 7 is placed such that the angle between the horizontal plane and the direction extending from the bottom 1 to the opening 2 along the central axis of the battery can 7 in the longitudinal direction of the cylindrical body 3 (the direction of the arrow P3) is approximately 0°, i.e., the direction of the arrow P3 is substantially parallel to the horizontal plane. Hence, the steam inside the battery can 7 is readily discharged without remaining in the can.

Also, the heater 6 is disposed such that the opening 8a is positioned in an upper part of in the transport route of the battery can 7 shown by the arrow Q3. Hence, the steam is prevented from flowing upward into the heater 6, so that the steam is unlikely to adhere to the heater 6. As a result, the failure of the heater 6 due to the adhesion of water can be suppressed.

Further, since the battery can 7 is transported in the direction substantially parallel to the horizontal plane from right to left, the adhesion of steam to the dried battery can 7 is suppressed.

### EMBODIMENT 4

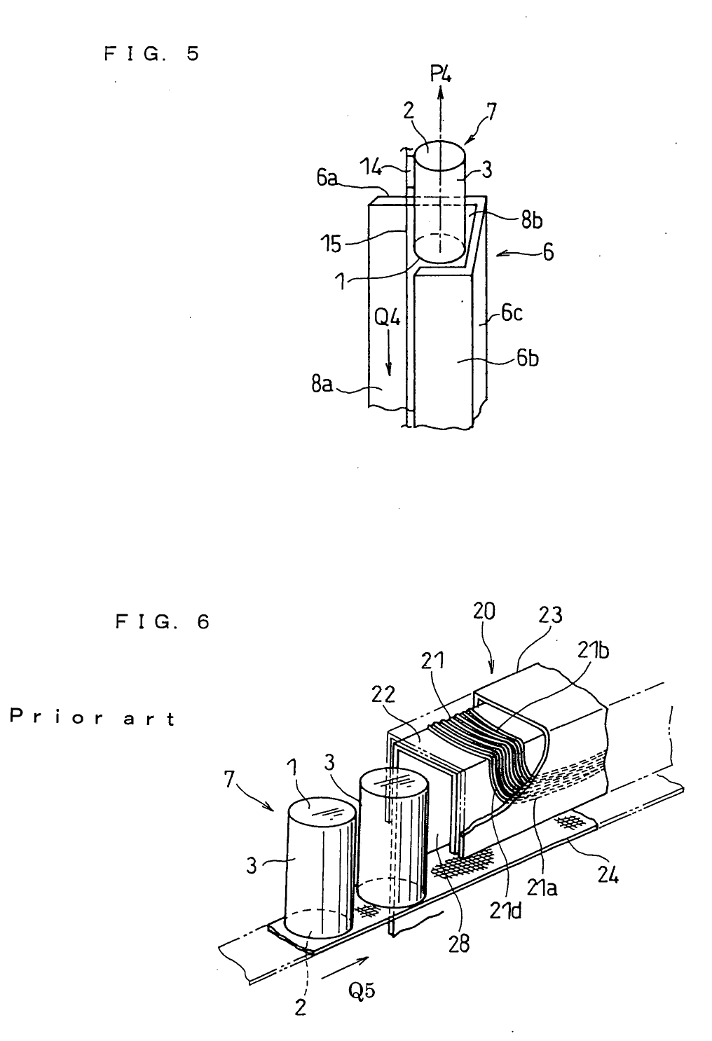

FIG. 5 illustrates a drying step in a battery can production method in this embodiment. FIG. 5 is a perspective view schematically showing a step of drying battery cans in this embodiment. The arrow P4 in FIG. 5 represents the direction extending from the bottom to the opening along the central axis of the battery can 7 in the longitudinal direction of the cylindrical body 3. The arrow Q4 in FIG. 5 represents the transport direction of the battery can 7.

This embodiment is the same as Embodiment 3, except that the orientations of the heater 6 and the magnet conveyer 15 are changed such that the battery can 7 is transported in the direction substantially perpendicular to the horizontal plane from up to down. That is, the positional relation between the battery cans 7 and the heater 6 is the same as that in Embodiment 3.

The battery can 7 is placed such that the angle between the horizontal plane and the direction extending from the bottom 1 to the opening 2 along the central axis of the battery can in the longitudinal direction of the cylindrical body 3 (the direction of the arrow P4) is approximately 90°. That is, the battery can 7 is placed such that the direction of the arrow P4 is substantially perpendicular to the horizontal plane and that the opening 2 points upward. Hence, the steam inside the battery can 7 is readily discharged without remaining in the can. Since the opening 2 points upward, the water adhering to the inner face of the battery can 7 can be removed more easily in this embodiment than in Embodiment 3.

Also, the heater 6 is disposed such that the transport entrance 8b is positioned in an upper part of the transport space 8 of the battery can 7. Hence, the steam is prevented from flowing upward into the heater 6, so that the steam is unlikely to adhere to the heater 6. As a result, the failure of the heater 6 due to the adhesion of water can be suppressed. The opening 8a facilitates the dissipation of the steam out of the transport space 8.

Further, since the battery can 7 is transported in the direction substantially perpendicular to the horizontal plane from up to down, the adhesion of steam to the dried battery can 7 is suppressed.

The battery can production method of the invention is preferably applied to battery cans for alkaline manganese batteries, Ni-MH batteries, Ni—Cd batteries, Li batteries, or the like.

Although the invention has been described in terms of the presently preferred embodiments, it is to be understood that such disclosure is not to be interpreted as limiting. Various alterations and modifications will no doubt become apparent to those skilled in the art to which the invention pertains, after having read the above disclosure. Accordingly, it is intended that the appended claims be interpreted as covering all alterations and modifications as fall within the true spirit and scope of the invention.

1. A method for producing a battery can, comprising the steps of:
(1) making a battery can having a cylindrical body, a bottom, and an opening from a steel plate;
(2) cleaning said battery can with water; and
(3) heating and drying said battery can by transporting said battery can through a high frequency induction heater after said step (2),
wherein in said step (3), said battery can is placed such that the angle between a horizontal plane and the direction extending from said bottom to said opening along the central axis of said battery can in the longitudinal direction of said cylindrical body is approximately 0° to 90°, and
said heater has an opening in an upper part of the transport route of said battery can and is placed so as not to face the opening of said battery can.

2. The method for producing a battery can in accordance with claim 1, wherein in said step (3), said battery can is placed such that the direction extending from said bottom to said opening along the central axis of said battery can in the longitudinal direction of said cylindrical body is substantially parallel to the horizontal plane, said battery can is transported in a direction substantially perpendicular to the horizontal plane from up to down, and said heater is placed so as to face the cylindrical body and the bottom of said battery can.

3. The method for producing a battery can in accordance with claim 1, wherein in said step (3), said battery can is placed such that the direction extending from said bottom to said opening along the central axis of said battery can in the longitudinal direction of said cylindrical body is substantially perpendicular to the horizontal plane, said battery can is transported in a direction substantially parallel to the horizontal plane, and said heater is placed so as to face the cylindrical body and the bottom of said battery can.

4. The method for producing a battery can in accordance with claim 1, wherein in said step (3), said battery can is placed such that the direction extending from said bottom to said opening along the central axis of said battery can in the longitudinal direction of said cylindrical body battery can in the longitudinal direction thereof is substantially parallel to the horizontal plane, said battery can is transported in a direction substantially parallel to the horizontal plane, and said heater is placed so as to face the cylindrical body of said battery can.

5. The method for producing a battery can in accordance with claim 1, wherein in said step (3), said battery can is placed such that the direction extending from said bottom to said opening along the central axis of said battery can in the longitudinal direction of said cylindrical body is substantially perpendicular to the horizontal plane, said battery can is transported in a direction substantially perpendicular to the horizontal plane from up to down, and said heater is placed so as to face the cylindrical body of said battery can.
